(19) United States
(12) Patent Application Publication
(10) Pub. No.: US 2015/0369445 A1
(43) Pub. Date: Dec. 24, 2015

(54) HEADLAMP AND/OR TAIL LIGHT ASSEMBLY, SYSTEM AND METHOD

(71) Applicant: Valeo Lighting Systems North America, LLC, Seymour, IN (US)

(72) Inventors: Timothy Joseph Orr, Seymour, IN (US); John Steven Orisich, Columbus, IN (US)

(21) Appl. No.: 14/311,633

(22) Filed: Jun. 23, 2014

(51) Int. Cl. F21S 8/10; H05B 3/00

(52) U.S. Cl. CPC F21S 48/34; F21S 48/12; F21S 48/22; H05B 3/0004

(57) ABSTRACT

A headlamp and/or a tail light assembly having a heating element is shown. The heating element comprises a deflector that is adapted to be received on a component of the headlamp and/or tail light assembly and to direct heat towards an interior surface of a transparent cover or an outer lens in order to facilitate de-icing or condensation removal.

### BACKGROUND OF THE INVENTION

1. Field of the Invention

This invention relates to a headlamp and/or a tail light assembly and a heater and heating system, apparatus and method for use in a headlamp and/or a tail light assembly.

2. Description of the Related Art

Vehicles function in a range of environments and often encounter condensation or ice forming on surfaces of the various components of the vehicle, including the headlamp components. Ice buildup on exterior vehicle components, such as the headlamps and rear lights, is a common problem. A typical headlamp and/or a tail light assembly comprises an outer housing that receives a reflector. The reflector has a light source, such as the LED or a discharge lamp, for example. The housing is typically closed at the front by glass or plastic constituting a transparent cover or outer lens, which allows the emergence therethrough of light produced by the light source and reflected by the reflector. The optical members, such as the reflector or similar apparatus, are placed within the chamber forming a light beam from the light produced by the light source.

The housing also houses the additional accessories and/or additional means necessary for the operation of the headlamp and/or a tail light assembly, such as the electronic circuits and controls for controlling the operation of the headlamp and/or means for its mobility, wiring or the like. Such accessories and complementary means are deemed unsightly and are therefore housed within an interior compartment formed at the base of the housing. Also, the direct visual access to the housing wall is often detrimental to the overall appearance and aesthetics of the headlamp and/or a tail light assembly as it is often designed in a material that is unattractive to the eye. To prevent visual access to the external supplementary means and/or the inner components within the housing through the transparent cover or outer lens, an inner mass or bezel is placed at the base of the transparent cover or outer lens to cover those components.

The housing is configured so as to be sealed against water penetration, such as water run-off from other components of the vehicle, while being permeable to air to allow ventilation of the interior thereof. This ventilation is necessary due to the heat generated by the light source, which requires balancing the pressure between the inside and the outside of the housing. Such sealing and permeability of the housing are, for example, obtained by means of, for example, labyrinth baffles or other valves or apertures.

Vehicles are typically designed with a pair of headlamps and a pair of rear lamps. Condensation and ice buildup on the vehicle light assemblies is quite common. In the past, headlamps were based on incandescent bulb technology, an example being halogen bulbs. Halogen bulbs were placed within an enclosure having a cover and light generated by the bulbs was directed out through the cover. Halogen bulbs generate heat along with the light. Although generating some heat, this heat was not sufficiently effective to prevent the formation of condensation on the cover. To improve illumination efficiency one or more light-emitting diodes (“LED”) were designed to replace the halogen bulbs and other light sources. LEDs provide beneficial reduction in power consumption and generally last longer than other types of light sources, but do not generate sufficient heat to prevent the accumulation of condensation on the inside of the transparent cover or outer lens of the headlamp and/or a tail light assembly. In addition, due to packing requirements and attempts to increase efficiency and aesthetics, the amount of air flowing through the headlamp enclosure has been substantially reduced. Therefore, substantial condensation issues exist, including not only the unsightly formation of condensation, but also the potential for reduced driver visibility. Similar issues have caused ice formation on the transparent covers or outer lenses of the headlamp and/or a tail light assembly.

In the case of condensation, warmer air can hold more moisture than colder air, thus the combination of relatively warm moist air with a cooler surface tends to generate condensation on the cooler surface. While it is possible for condensation to form on many parts of the vehicle, condensation is most noticeable and aesthetically objectionable on transparent surfaces, such as the vehicle windshield and, for example, on the transparent cover or outer lens of the vehicle headlamps. Condensation tends to form on surfaces like the transparent cover or outer lens for the headlamps because interior air is relatively warm and moist while the transparent cover or outer lens itself on the outer surface is relatively cool due to the flow of cool exterior air over the transparent cover or outer lens. Once the relatively warm and moist interior air contacts the inner surface of the transparent cover or outer lens, it tends to cool and condense on the inside of the transparent cover or outer lens. Methods of controlling the formation of condensation (i.e., causing the condensation to evaporate) include lowering the level of moisture in the interior air, increasing the airflow across the inside surface of the transparent cover or outer lens and further heating the air.

Condensation of moisture on the transparent cover or outer lens is not desirable not only when the headlamp is in operation, but also when the vehicle is stopped and the light source is turned off. To prevent fogging of the glass cover, it was previously proposed to heat the glass cover by integrating in the glass cover heating elements such as resistors, electrode, heating film or the like. Unfortunately, such provisions have the disadvantage of altering the optical quality of the transparent glass cover or outer lens for projection of the light beam from the light source to induce an increase in the cost of inappropriate glass or transparent cover and outer lens and generate electrical consumption.

To avoid the use of the electrical energy, it was proposed to use the heat generated by the light source to heat the glass cover, as described in DE 10255443. A stream of hot air generated by the heat present in the chamber is directed towards the inner face of the transparent cover or outer lens so as to be scanned by the heat. Such provisions are unsatisfactory to the extent that their implementation is subject to the waste heat produced by the light source, and therefore, they may not be able to meet when the heat is inadequate or non-existent at all. Such a solution is more applicable to a restricted type of light source capable of producing sufficient heat, such as a discharge lamp or halogen lamp. In many cases with the light source utilizing LEDs, not enough heat is generated to provide sufficient hot airflow. In addition, the formation of passages of hot airflow through the mask prejudice to its primary function of having to hide the components of the headlamp and/or a tail light assembly and therefore reduce the overall aesthetics of the headlamp.

Another approach to reducing moisture is shown in DE 10319363. A thermal electric unit is activated depending on weather conditions, including rain and outdoor temperatures. The use of the thermal active unit is satisfactory in view of the lower power consumption required for its implementation. However, such provisions of causing condensation in a dedicated area of the housing are insufficient to ensure preservation of reducing or elimination of ice and fog. These provisions do not allow for fast and efficient de-misting or de-icing and/or condensation removal and the prior implementation of the thermal electric unit does not meet users' expectations.

Existing solutions for de-icing and eliminating condensation to the transparent cover or outer lens to reduce the humidity inside the headlamp and/or a tail light assembly are not satisfactory with regard to all requirements, including cost of obtaining and/or limiting operation of the device used, its small footprint in the overall headlamp and/or a tail light assembly and of providing a de-icer that is effective to achieve quick condensation removal and de-icing that improves the overall operation of the headlamp and/or a tail light assembly and perhaps provides improved visibility to the driver.

What is needed, therefore, is an assembly, system and method that facilitates reducing condensation and providing a system, means and method for de-icing a headlamp and/or a tail light assembly.

### SUMMARY OF THE INVENTION

It is, therefore, an object of the invention to provide a heater for a headlamp and/or a tail light assembly that is adapted to reduce and/or eliminate condensation that is capable of de-icing the transparent cover or outer lens of the headlamp and/or a tail light assembly.

Another object of the invention is to provide a headlamp and/or a tail light assembly having a heater that is adapted to reduce and/or eliminate condensation and that is capable of de-icing the transparent cover or outer lens of the headlamp and/or a tail light assembly.

Still another object of the invention is to provide a heater for use in a headlamp and/or a tail light assembly that comprises a deflector or reflector that is adapted to deflect and/or direct heat to an inner surface of the transparent cover or outer lens.

Yet another object of the invention is to provide a system and method for reducing condensation on the inner surface of the transparent cover or outer lens and/or de-icing the transparent cover or outer lens even during times when a light source in the headlamp and/or a tail light assembly is not on.

Still another object of the invention is to provide a headlamp and/or a tail light assembly having a heater unit that comprises a deflector having a deflective or reflective surface that is slightly angled to facilitate directing heat toward the inner surface of the transparent cover or outer lens.

Another object of the invention is to provide a heater having a deflector or reflector that houses the heater core such that when the deflector or reflector is mounted to a component of the headlamp and/or a tail light assembly, such as a bezel, the deflector or reflector becomes situated in a predetermined relationship with respect to the transparent cover or outer lens to facilitate directing heat toward the inner surface of the transparent cover or outer lens.

Another object of the invention is to provide a heater having a deflector or reflector that becomes situated a predetermined distance from an inner surface of the transparent cover or outer lens after it is mounted in the headlamp and/or a tail light assembly.

In one aspect, one embodiment of the invention comprises a headlamp and/or a tail light assembly comprising a housing, an outer lens and a heater having a heater core for producing heat, a deflector or reflector for receiving the heater core, the deflector or reflector being configured to direct or reflect heat from the heating core toward the outer lens.

In another aspect, another embodiment of the invention comprises a method for heating a outer lens in a headlamp and/or a tail light assembly comprising the steps of providing a heater having a heater core for producing heat, a deflector or reflector for receiving the heater core and mounting the heater in the headlamp and/or a tail light assembly such that the deflector or reflector directs heat toward an inner surface of an outer lens of the headlamp and/or a tail light assembly.

In still another aspect, another embodiment of the invention comprises a heater for use in a headlamp and/or a tail light assembly comprising a heater core for producing heat, a deflector or reflector for receiving the heater core, the deflector or reflector being configured to direct or reflect heat from the heating core toward an outer lens.

This invention, including all embodiments shown and described herein, could be used alone or together and/or in combination with one or more of the features covered by one or more of the claims set forth herein, including but not limited to one or more of the features or steps mentioned in the following bullet list and the claims.

The headlamp and/or a tail light assembly wherein the deflector or reflector comprises an angled, curved or non-linear wall portion for directing or reflecting heat from the heater core to the outer lens.

The headlamp and/or a tail light assembly wherein the deflector or reflector comprises a first wall and a generally opposing second wall; at least one of the first wall or the second wall being angled or curved to direct or reflect heat from the heater core toward the outer lens.

The headlamp and/or a tail light assembly wherein each of the first wall and the generally opposing second wall are angled or curved to direct or reflect heat from the heater core toward the outer lens.

The headlamp and/or a tail light assembly wherein the deflector or reflector is generally U-shaped, V-shaped or L-shaped in cross section and further comprises a joining wall for joining a first wall and a second wall and cooperating therewith to provide or define a receiving area for receiving the heater core.

The headlamp and/or a tail light assembly wherein the heater is mounted on the housing.

The headlamp and/or a tail light assembly wherein the headlamp and/or a tail light assembly comprises a bezel having a recessed wall defining a bezel recessed area for receiving the heater.

The headlamp and/or a tail light assembly wherein the deflector or reflector comprises a deflector housing for receiving the heater core, the deflector housing being configured and adapted to be receiving in the bezel recessed area.

The headlamp and/or a tail light assembly wherein the deflector or reflector comprises a deflector housing having a wall that is curved, non-linear or angled at a predetermined angle to direct heat toward the outer lens.

The headlamp and/or a tail light assembly wherein the angle is about 45 degrees.

The headlamp and/or a tail light assembly wherein the deflector or reflector comprises a deflector housing having a wall edge in opposed and operative relationship with an inner surface of the outer lens.

The headlamp and/or a tail light assembly wherein the wall edge is spaced from the inner surface a distance of 10.0 mm or less.

The headlamp and/or a tail light assembly wherein the deflector housing comprises a first wall having a first wall edge associated with a first area of the outer lens and a second wall edge associated with a second area of the outer lens; the second edge being spaced a predetermined distance from the second area to define an opening between the second edge and the outer lens to facilitate the passing of convection currents across an inner surface of the outer lens.

The headlamp and/or a tail light assembly wherein the first edge is spaced a second predetermined distance from the first area.

The headlamp and/or a tail light assembly wherein the second wall is angled to direct or reflect heat from the heater core toward the opening.

The headlamp and/or a tail light assembly wherein the predetermined distance is less than 10.0 mm.

The headlamp and/or a tail light assembly wherein at least an inner surface of the deflector housing is metallized or the deflector or reflector is made of a metallic material.

The headlamp and/or a tail light assembly wherein the deflector or reflector comprises a deflector housing that is secured to the outer lens.

The headlamp and/or a tail light assembly wherein the deflector or reflector housing is molded to the outer lens.

The headlamp and/or a tail light assembly wherein the deflector or reflector comprises a deflector housing that is secured to the outer lens.

The headlamp and/or a tail light assembly wherein the heater core is coupled to an electrical circuit for energizing the heater core.

The headlamp and/or a tail light assembly wherein the heater core comprises a mandrel for receiving and supporting a heating element.

The headlamp and/or a tail light assembly wherein the mandrel is generally cylindrical .

The headlamp and/or a tail light assembly wherein the heating element is a helically-shaped wire situated on the mandrel.

The headlamp and/or a tail light assembly wherein the mandrel is generally planar and comprises a plurality of channels for receiving a heating element for generating heat in response to current from an electrical circuit.

The headlamp and/or a tail light assembly wherein the mandrel is generally planar and comprises grooves for receiving the heating element.

The headlamp and/or a tail light assembly wherein the deflector or reflector is generally U-shaped, L-shaped or V-shaped in cross section and defines a deflector opening, the deflector or reflector being mounted in the headlamp and/or a tail light assembly such that the deflector opening is in operative relationship with the outer lens so that heat from the heater core is directed to the outer lens.

The headlamp and/or a tail light assembly wherein the heating element is a wire.

The headlamp and/or a tail light assembly wherein the outer lens comprises a convex or curved shape that defines a recessed area in the outer lens, the deflector or reflector having a housing that having an opening which generally opposes the recessed area.

The headlamp and/or a tail light assembly wherein the curved shape of the outer lens has two sides: one concave side which is the recessed area opposed to the opening of the deflector or reflector housing, and one convex side located inside a recess of the headlamp housing. This shape enables the positioning of the outer lens inside the headlamp housing before fixing the outer lens to the housing. This specific embodiment uses the other side of this shape by placing the deflector or reflector housing. It provides two technical functions to this area: on one side the said positioning and on the other side defining the cavity for placing the rod and the air pathway towards this cavity.

The headlamp and/or a tail light assembly wherein the heater is situated in the housing in opposed relationship to the recessed area.

The headlamp and/or a tail light assembly wherein the deflector or reflector comprises a deflector or reflector housing that is adapted to complement a shape of the outer lens in order to define an air channel that extends from below the deflector or reflector housing, generally horizontally or generally perpendicular toward the outer lens, then generally vertically upward or generally parallel to and across at least one surface of the outer lens.

The headlamp and/or a tail light assembly wherein the deflector or reflector comprises a deflector or reflector housing having a plurality of surfaces that are adapted to define a predetermined deflector or reflector shape or configuration, the outer lens having a predetermined outer lens shape or configuration, the predetermined deflector or reflector shape or configuration cooperating with the predetermined outer lens shape or configuration to define an air channel or passageway that has a generally vertical area in communication with a generally horizontal area for directing air toward a outer lens recessed area defined by the outer lens, the air channel or passageway also having a generally vertical area for directing air away from the outer lens recessed area and across a surface of the outer lens after it is heated by the heater.

The headlamp and/or a tail light assembly wherein the outer lens comprises a convex or curved shape that defines the outer lens recessed area, the deflector or reflector having a housing wall defining an opening which generally opposes the recessed area.

The method for heating an outer lens in a headlamp and/or a tail light assembly wherein the deflector or reflector is generally U-shaped, L-shaped or V-shaped in cross section and defines a deflector opening, the mounting step further comprising the step of mounting the deflector or reflector in the headlamp and/or a tail light assembly such that the deflector opening is situated in generally opposed and spaced relationship from the inner surface of the outer lens.

The method for heating an outer lens in a headlamp and/or a tail light assembly wherein the deflector or reflector comprises a wall having an edge surface that cooperates with the inner surface of the outer lens to define a current gap through which a convection current may pass, a distance between the edge surface and the inner surface being at least 10.0 mm.

The heater for use in a headlamp and/or a tail light assembly wherein the deflector or reflector comprises an angled or curved wall portion configured to direct or reflect heat from the heater core to the outer lens or transparent cover.

The heater for use in a headlamp and/or a tail light assembly wherein the deflector or reflector comprises a first wall and a generally opposing second wall; at least one of the first wall or the second wall defining the angled or curved wall portion configured to direct or reflect heat from the heater core toward the outer lens or transparent cover.

The heater for use in a headlamp and/or a tail light assembly wherein each of the first wall and the generally opposing second wall are angled to direct or reflect heat from the heater core toward the outer lens or transparent cover.

The heater for use in a headlamp and/or a tail light assembly wherein the deflector or reflector is generally U-shaped, V-shaped or L-shaped in cross section and further comprises a joining wall for joining a first wall and a second wall and cooperating therewith to provide or define a receiving area for receiving the heater core.

The heater for use in a headlamp and/or a tail light assembly wherein the heater is mounted on a bezel of the headlamp and/or a tail light assembly.

The heater for use in a headlamp and/or a tail light assembly wherein the bezel comprises a recessed wall defining a bezel recessed area for receiving the heater.

The heater for use in a headlamp and/or a tail light assembly wherein the deflector or reflector comprises a deflector or reflector housing for receiving the heater core, the deflector or reflector housing being configured and adapted to be receiving in the bezel recessed area.

These and other objects and advantages of the invention will be apparent from the following description, the accompanying drawings and the appended claims.

### BRIEF DESCRIPTION OF THE ACCOMPANYING DRAWINGS

FIG. 1A is a view of headlamp and/or a tail light assembly having a heater in accordance with one embodiment of the invention;

FIG. 1B is a fragmentary view of the assembly shown in FIG. 1A illustrating features of the embodiment;

FIG. 2 is an exploded view of an upper half of the headlamp and/or a tail light assembly shown in FIG. 1;

FIG. 3 is an enlarged exploded view of a portion of the headlamp and/or a tail light assembly shown in FIG. 1 illustrating a relationship between a heater and deflector relative to a transparent cover or outer lens;

FIG. 4A is a view of a bezel with an exterior bezel and outer lens;

FIG. 4B is a view of a bezel without the exterior bezel or outer lens;

FIG. 5 is a view of the components of the heater showing a cylindrical mandrel that receives a helical wire, both of which are received and supported in the deflector;

FIG. 6 is an exemplary circuit for energizing the heating element or wire shown in FIG. 5;

FIG. 7 is an enlarged view of the heater shown in FIG. 5;

FIG. 8 is an exploded view showing components of the heater and use of a heating element or core;

FIG. 9 is a rear view of the deflector shown in FIG. 8; and

FIG. 10 is a view of a generally planar heating core or mandrel that could be used in place of the cylindrical heating core or rod shown in FIGS. 7 and 8.

### DETAILED DESCRIPTION OF THE PREFERRED EMBODIMENTS

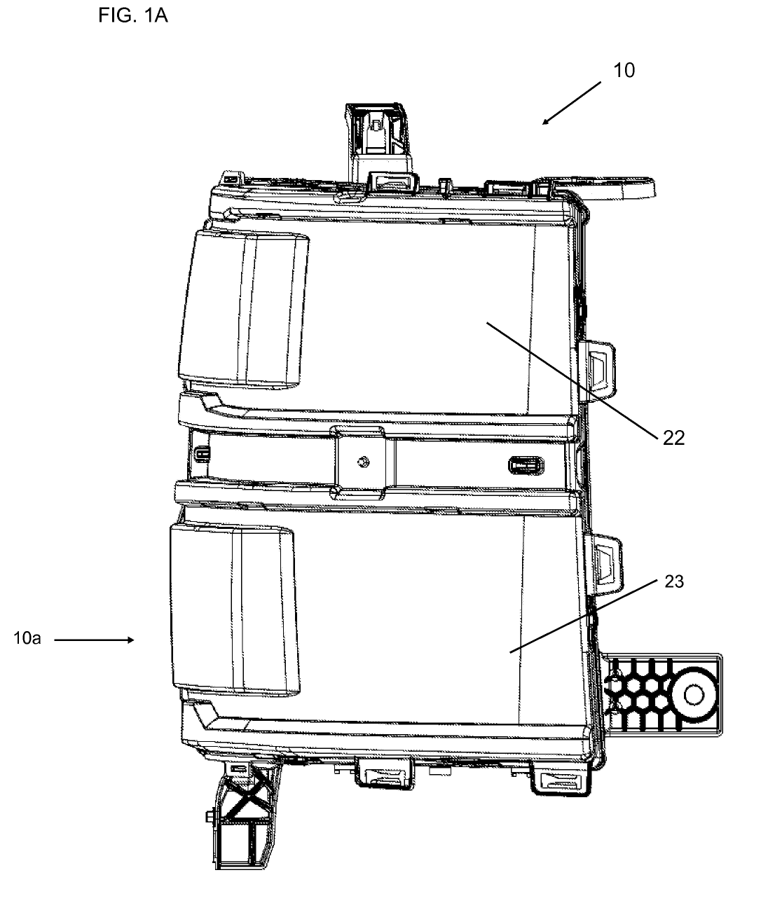

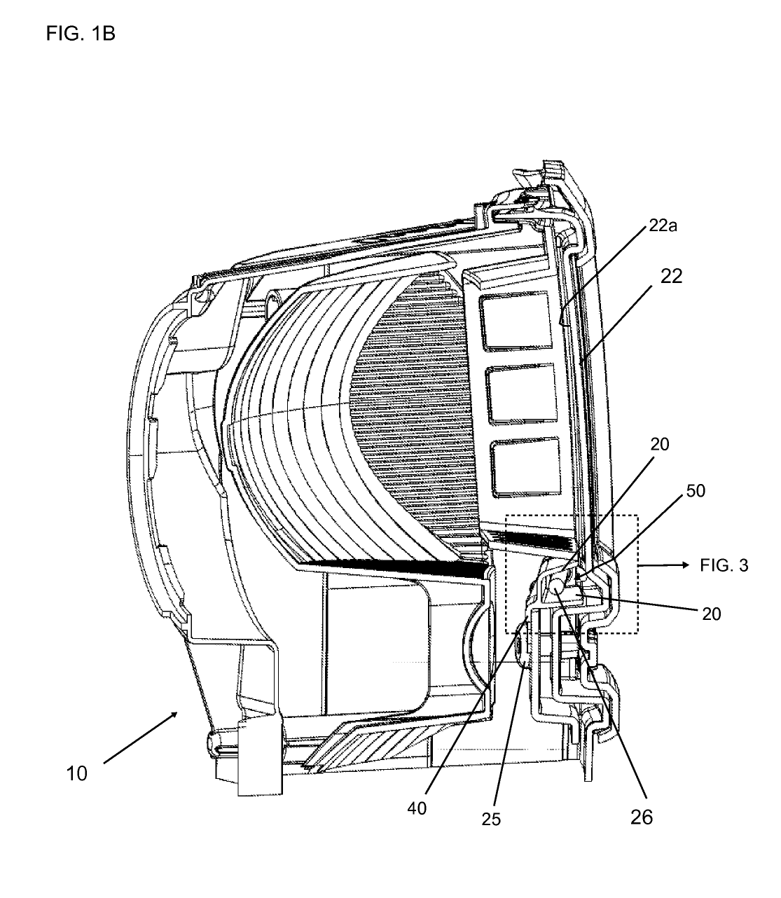

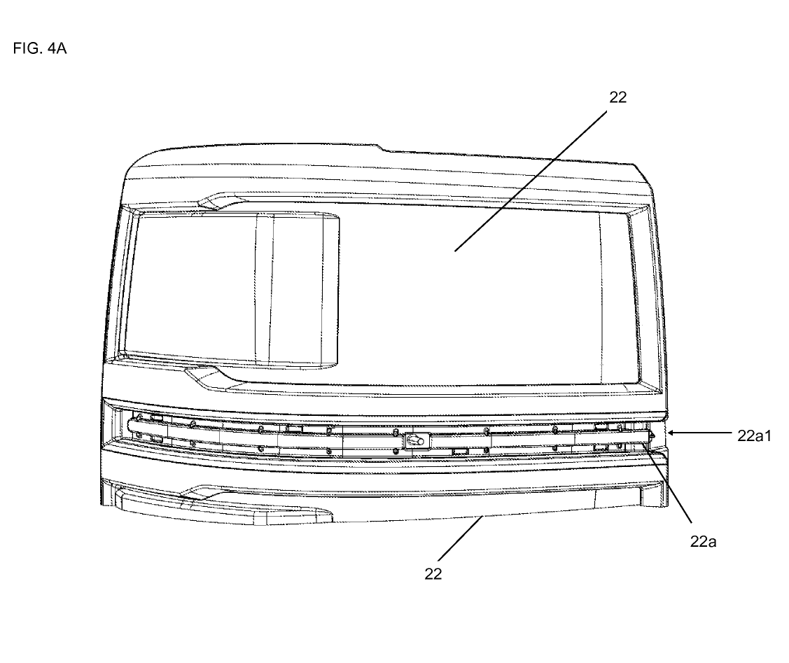

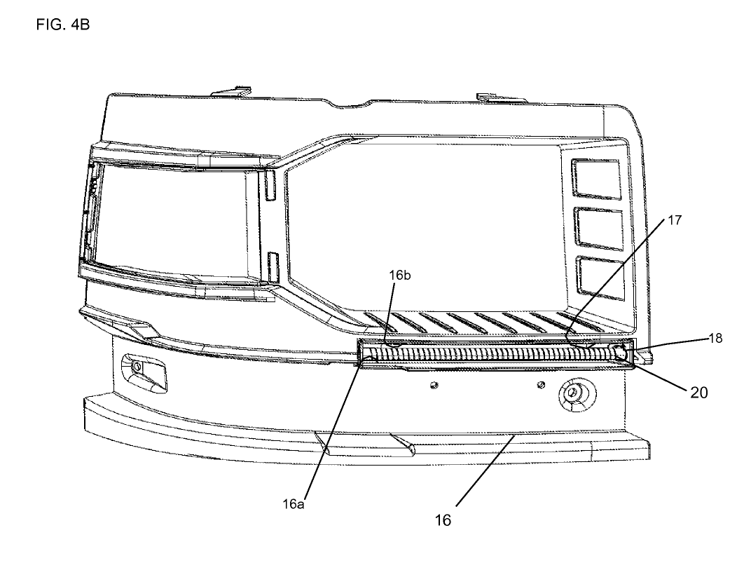

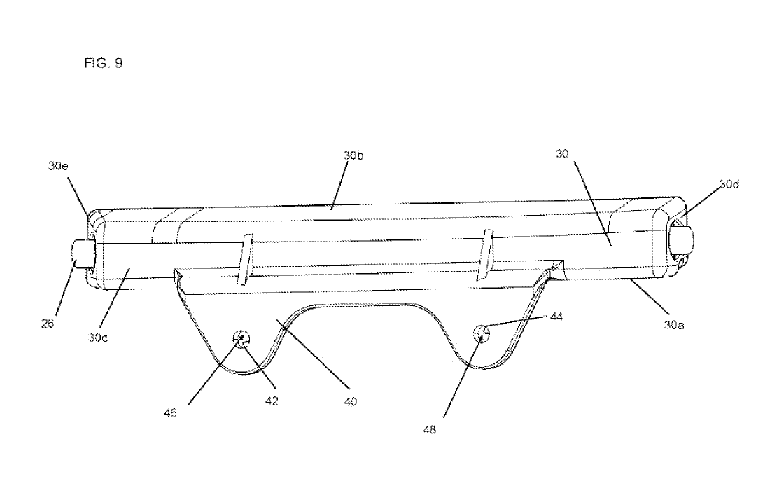

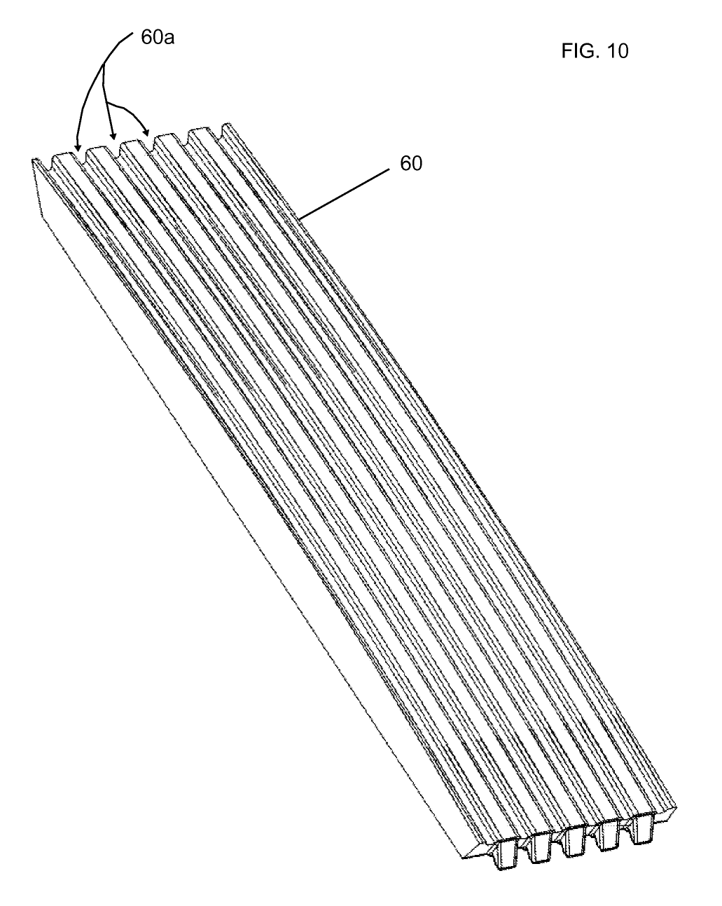

Referring now to FIGS. 1A-10, a headlamp and/or a tail light assembly, system and method are shown. The headlamp and/or a tail light assembly 10 is shown in FIG. 1A and comprises a housing 12 having a reflector 14 conventionally mounted therein. For ease of illustration, FIGS. 1B-4B show fragmentary views only of an upper half of the headlamp and/or a tail light assembly shown in FIG. 1. At least one or a plurality of light sources 15, such as light-emitting diodes (LEDs) or halogen bulbs, are mounted in the reflector 14. The headlamp and/or a tail light assembly 10 further comprises a bezel 16 that is conventionally mounted on the housing 12 with suitable fasteners such as screws (not shown). The bezel 16 contains a generally rectangular wall 17 that defines a generally rectangular cut-out area 18 (FIG. 4B) that receives a heater 20 which will be described later herein. The heater 20 is mounted to the bezel 16 using conventional fasteners, such as screws 25 (FIG. 1B), but other means (such as an adhesive or bond) for securing the heater 20 to the bezel 16 could be used.

The headlamp and/or a tail light assembly 10 further comprises a transparent cover or outer lens 22 that is conventionally secured to the housing 12. In the illustration being described, the transparent cover or outer lens 22 is an outer lens of the headlamp and/or a tail light assembly 10. It should be understood that once the headlamp and/or a tail light assembly 10 is assembled, the heater 20 becomes hidden from view and operatively associated with the transparent cover or outer lens 22 so that when the heater 20 is energized, the heater 20 heats an inner surface 22a (FIGS. 1B and 2) of the transparent cover or outer lens 22 in order to remove condensation and/or de-ice at least one or both of the inner surface 22a or the outer surface 22b of the transparent cover or outer lens 22.

In one illustrative embodiment, the heater 20 is mounted on the bezel 16, but it could be integrally formed or molded thereon if desired. It should be understood, however, that the heater 20 could be mounted directly to or integrally formed on other components of the headlamp and/or a tail light assembly 10, such as the housing 12 or even the transparent cover or outer lens 22, although the preferred embodiment is to mount the heater 20 directly on the bezel 16 using the screws 25 (FIG. 2).

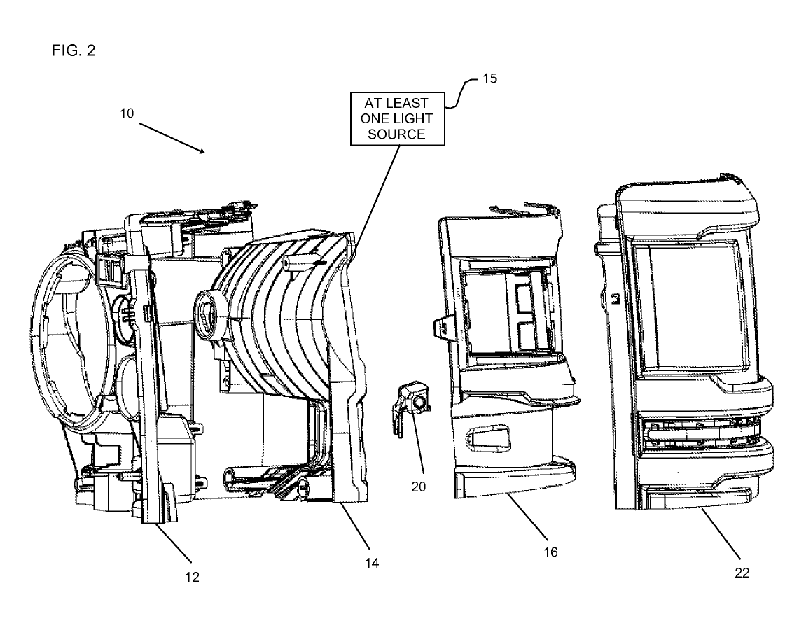

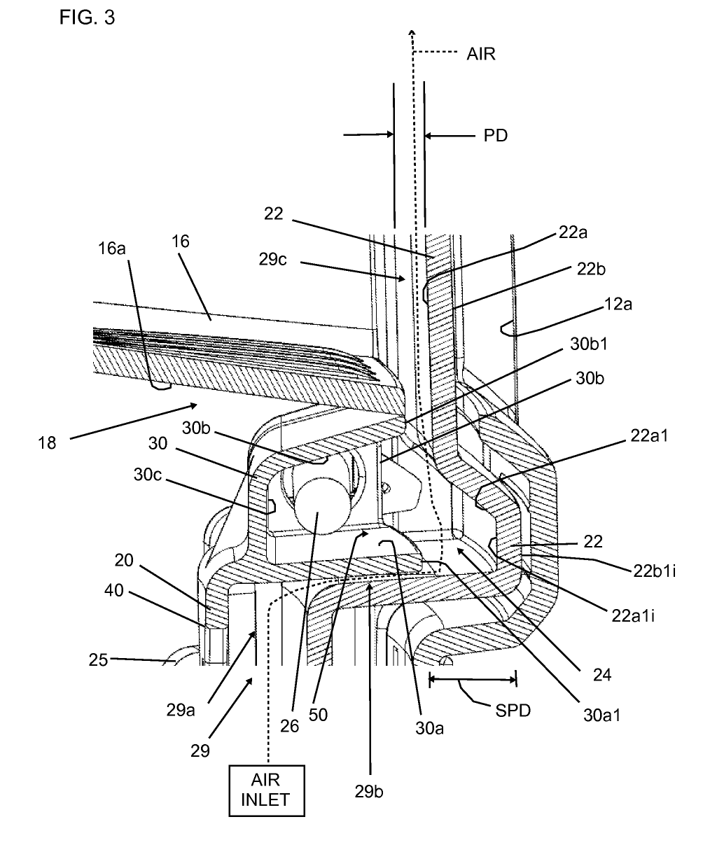

In the illustration being described, the heater 20, when energized, facilitates de-icing and clearing condensation from the inner surface 22a and/or the outer surface 22b of the transparent cover or outer lens 22. Accordingly, it is desirable to situate the heater 20 in the headlamp and/or a tail light assembly 10 (e.g., the bezel 16) so that it is situated in relatively close proximity to the inner surface 22a of the transparent cover or outer lens 22 to increase a temperature and airflow in an area 24 (FIG. 3) associated with the transparent cover or outer lens 22. As mentioned earlier, the inventors have found that by placing the heater 20 in operative relationship with the cut-out area 18 (FIG. 3) of the bezel 16 and causing the bezel 16 and heater 20 to be situated in operative relationship and relatively close proximity to the transparent cover or outer lens 22, the heater 20 is capable of not only removing condensation from the transparent cover or outer lens 22, but is also capable of de-icing the inner surface 22a and the outer surface 22b of the transparent cover or outer lens 22. It should be appreciated that the headlamp or tail light assembly 10 comprises the outer lens 22 that has the inner surface or side 22a and the outer surface or side 22b. The inner surface or side 22a is adapted and has a concave portion 22a1i that defines the recessed area 24 and that is generally opposed to the opening 50 of the deflector or reflector housing 12. The outer lens or cover 22 also has a convex portion 22b1i (FIG. 3) of the outer surface or side 22b is located and received inside a recess 12a of the housing 12.

Referring now to FIGS. 3-10, details of the heater 20 and bezel 16 will now be described. The heater 20 comprises a heater core or mandrel 26 having a heating element 28 situated thereon. In the illustrative embodiment, the heating element 28 is a conventional conductive copper wire that is helically formed and that, when energized, heats to a temperature of at least 200 degrees Fahrenheit to generate at least 17.1 British Thermal Units (BTUs), or 10 W*1800 sec=18000 joules=17.1 BTUs, when a current of about 1 ampere is applied thereto.

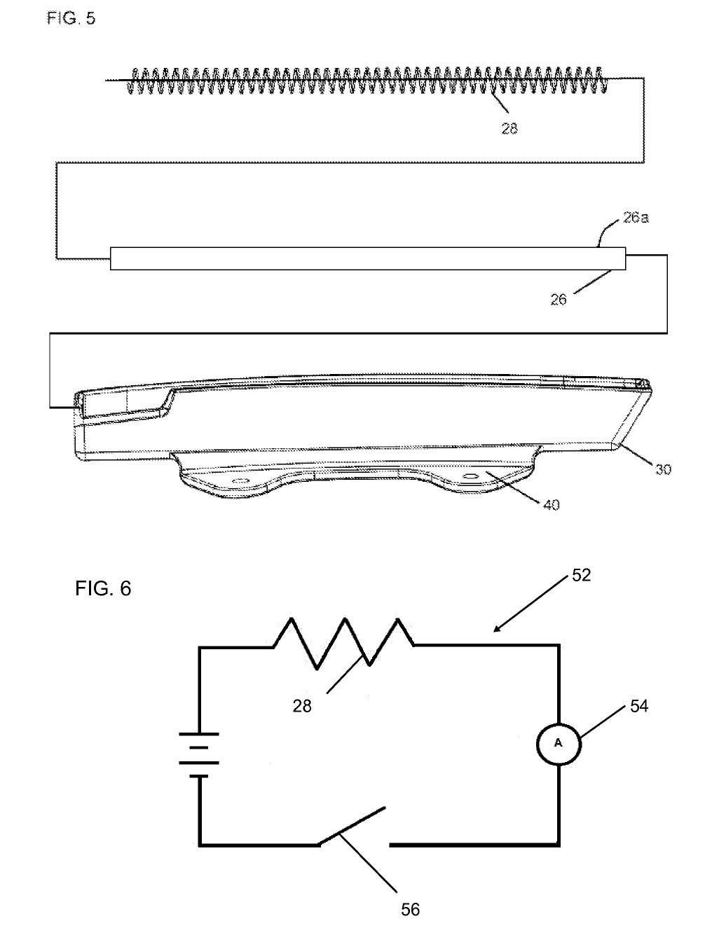

The heater 20 further comprises a reflector or deflector 30 for receiving and supporting the heater core or mandrel 26 and heating element 28. In the illustration being described, the heater core or mandrel 26 is generally cylindrical and receives the helical shaped or formed heating element 28 as illustrated in FIGS. 5, 7 and 9. The heater core or mandrel 26 could be provided in a non-cylindrical shape, such as a planar shape, as is illustrated in FIG. 10.

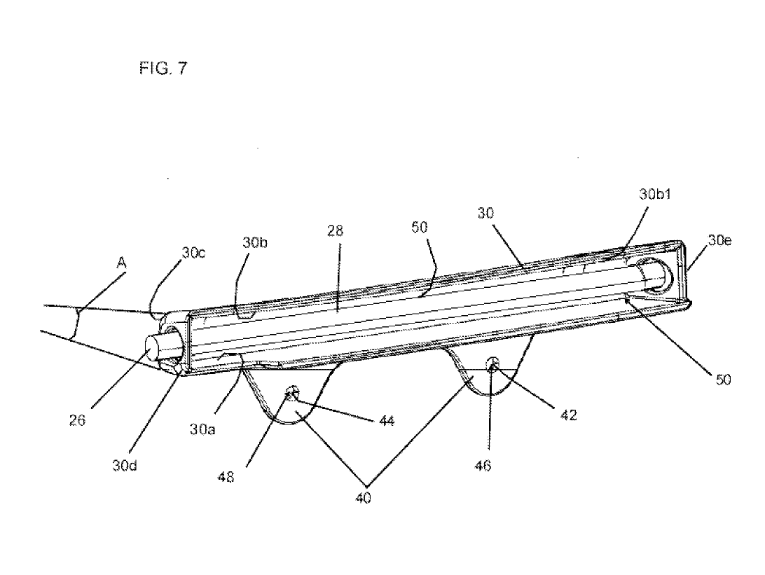

In one embodiment, the reflector or deflector 30 comprises a first wall portion 30a (FIGS. 3, 7 and 8), a second wall portion 30b and a joining portion 30c that joins the first and second wall portions 30a and 30b as shown. The reflector or deflector 30 further comprises a pair of generally opposing end wall portions 30d (FIGS. 7) and 30e as shown. Note that the end wall portions 30d and 30e comprise internal generally cylindrical walls 32 and 34, respectively, which define apertures 36 and 38 for receiving and supporting the heater core or mandrel 26. In the illustration being described and as shown in FIG. 3, the reflector or deflector 30 is generally U-shaped in cross-section. However, it could be generally V-shaped or even generally L-shaped, for example, if the reflector or deflector 30 were provided without the bottom or first wall portion 30a.

In one illustrative embodiment, the wall portions 30a-30e are about 2.0 mm thick and made of a thermally-conductive material, such as metal or plastic. These surfaces 30a-30e may be metallized to facilitate reflection or deflection of heat.

It is important to note that the transparent cover or outer lens 22 comprises a recessed wall portion 22a1 that defines the area 24 mentioned earlier herein. Note that the first wall portion 30a comprises the first edge 30a1 that generally opposes the area 24 and the wall portion 22a1 of the transparent cover or outer lens 22. In the illustration being described, the first edge 30a1 is a second predetermined distance (SPD) from the wall portion 22a1 as illustrated in FIG. 3. It is also important to note that the wall portion 22a1 is convex (relative to the outside of the headlamp and/or a tail light assembly 10) or curved in shaped and defines the recessed area 24. Note that when the reflector or deflector 30 is mounted in the headlamp and/or a tail light assembly 10, the opening 50 is generally opposed to the area 24 and the housing 12 supports the heating element 28 in operative or a generally opposed relationship to the area 24. This area 24 facilitates heating the air as it travels from an air inlet in the housing through a channel or passageway 29 (FIG. 3) and ultimately generally vertically upward (as viewed in the figure) across the inner surface 22a of the transparent cover or outer lens 22 as best illustrated in FIG. 3. Thus, the heater 20 cooperates with the transparent cover or outer lens 22 to define the air channel or passageway 29 that extends from below the reflector or deflector 30, generally horizontally or generally perpendicular toward the transparent cover or outer lens 22, and then generally vertically upward or generally parallel to and across the inner surface 22a of the transparent cover or outer lens 22.

Thus, the reflector or deflector 30 comprises the housing 12 having a plurality of surfaces 30a, 30b and 30c that are adapted to define a predetermined deflector or reflector shape or configuration, which is generally U-shaped in the illustration shown in FIG. 3, with the transparent cover or outer lens 22 having a predetermined outer lens shape or configuration which is also generally U-shaped, curved or convex, when viewed from outside the transparent cover or outer lens 22. The predetermined deflector or reflector shape or configuration cooperates with the predetermined outer lens shape defined by the inner wall 22a1 of the transparent cover or outer lens 22 and facilitates defining at least a portion of the air channel or passageway 29. As illustrated in FIG. 3, note that the air channel or passageway 29 has a generally vertical area 29a below the reflector or deflector 30 and then a generally horizontal area 29b that is in communication with the area 24, which in turn is in communication with another general vertical area 29c so that air can be directed from underneath the heater 20 and into the area 24 where it can be heated and then exit through the vertical area 29c after it passes across the inner surface 22a of the transparent cover or outer lens 22.

As illustrated in FIG. 4B and as mentioned earlier, the bezel 16 comprises the generally rectangular wall 17 that defines the cut-out area 18 mentioned earlier herein and which is sized and adapted to receive the heater 20, as best illustrated in FIG. 3. In this regard, note that the reflector or deflector 30 is generally sized and adapted to fit inside the cut-out area 18. Once the transparent cover or outer lens 22 is mounted to the housing 12, the heater 20 becomes hidden behind an opaque area or wall portion 22a1 of inner surface 22a (FIGS. 3 and 4A) of the transparent cover or outer lens 22 (when viewed from in front of the transparent cover or outer lens 22) so that it does not interfere with the overall aesthetics of the headlamp and/or a tail light assembly 10.

The reflector or deflector 30 comprises a generally planar mounting projection 40 that projects downwardly (as viewed in FIGS. 7-10). The mounting projection 40 comprises a plurality of interior cylindrical walls 42 and 44 that define mounting apertures 46 and 48, respectively, for mounting the heater 20 to the bezel 16 using suitable fasteners, such as a screw 25 (FIGS. 1B and 3). As illustrated in FIG. 3 and as mentioned earlier, note that once the heater 20 is mounted to the bezel 16, the heater 20, and particularly the heater core or mandrel 26 and heating element 28, become operatively associated with the inner surface 22a of the transparent cover or outer lens 22.

Referring back to FIG. 3, the first, second and third wall portions 30a, 30b and 30c define a general U-shape in cross-section as mentioned earlier and also define an opening 50 which causes heat from the heating element 28 to be directed toward the transparent cover or outer lens 22 and upward (as viewed in FIG. 3) along the wall portion 22a1 when the heating element 28 is energized. In one embodiment, the heating element 28 is energized using a circuit 52 that is shown in FIG. 6. The circuit 52 comprises a power or current source 54 and at least one switch 56 that, when closed, causes current to flow through the heating element 28, thereby energizing the heating element 28 to generate heat which is directed by the reflector or deflector 30 through the opening 50 and toward the transparent cover or outer lens 22. Although not shown, the circuit 52 may be embedded in a microprocessor or controller (not shown) that comprises computer instructions for controlling the operation of the heater 20 and the heating element 28. Also, one or more input or feedback sensors could be used to control the heater. Such sensors include, but are not limited to, a humidity sensor, a light transmission sensor (TIR and visible), and one or more temperature sensors. Additionally, the heater could be actuated manually by the vehicle operator actuating a switch (not shown) that causes an energizing circuit to energize heating element 28. Also, the microprocessor or controller may comprise logic that energizes the heating element 28 even when the light source 15 (FIG. 1) of the headlamp and/or a tail light assembly 10 is not energized and if the heater is energized from the car battery directly.

Another advantageous feature of the illustration being described is that when the reflector or deflector 30 is mounted to the bezel 16, as illustrated in FIGS. 1B and 3, the opening 50 becomes situated a predetermined distance PD from the inner surface 22a of the transparent cover or outer lens 22. Note in FIG. 3 that the wall portion 30b comprises a front edge portion 30b1 that is situated the predetermined distance PD from the inner surface 22a of the transparent cover or outer lens 22. In the illustration being described, the predetermined distance PD is about 10.0 mm, but it could be smaller or larger if desired. The inventors have found that providing the predetermined distance PD between the front edge portion 30b1 and the inner surface 22a of the transparent cover or outer lens 22 facilitates generating a convection current and causing heat to travel upward (as viewed in FIG. 3) and across the inner surface 22a of the transparent cover or outer lens 22 in order to remove moisture and condensation and/or to de-ice the transparent cover or outer lens 22.

It is important to note that the upper or second wall portion 30b is angled upward (as viewed in FIG. 3) a predetermined angle A (FIG. 7) which further facilitates directing the heat from the area 24 inside the reflector or deflector 30, through the opening 50, and across the inner surface 22a of the transparent cover or outer lens 22. In the illustration, the angle A is, at a minimum, above zero degrees and a maximum of less that 90 degrees. In the illustration shown, the angle A is about 45 degrees, but it could be smaller or larger if desired. It should also be understood that one or more of the walls 30a, 30b or 30c could be curved or the housing 12 could have a parabolic or U-shape in cross-section.

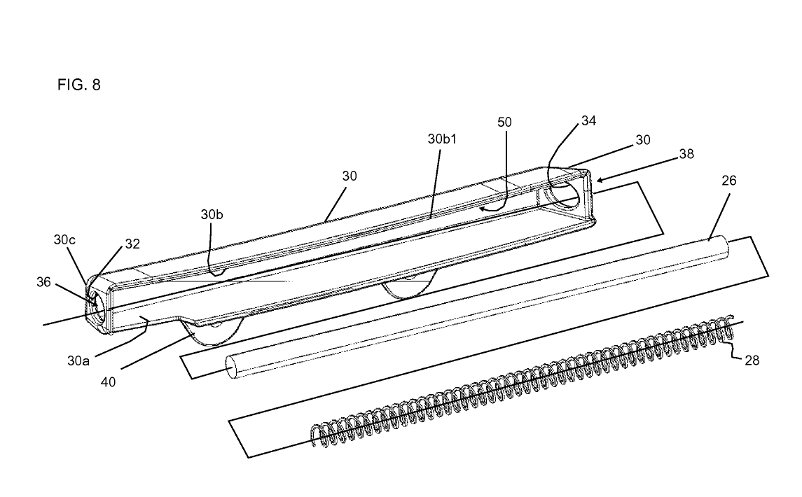

It is important to note in FIG. 8 that the heater core or mandrel 26 provides an insulative support that is adapted and sized to receive the heating element 28, which is a copper wire.

In the illustration being described, the reflector or deflector 30 is made of a metallic or thermally-conductive material approximately 2.0 mm thick as mentioned earlier, but the wall portions 30a-30e could be made of a non-metallic material, such as a polymeric material. If made of a non-metallic material, such as a thermally-conductive plastic, one or more of the surfaces, such as surfaces 30a1, 30b2 and 30c1 (FIG. 8), could be metallized as mentioned earlier to facilitate reflecting or deflecting heat through the opening 50 and out of the reflector or deflector 30.

While the embodiment shown illustrates the heating element 28 being generally helically-shaped, it should be understood that the heating element 28 does not have to be coiled or helically shaped. For example, FIG. 10 shows a generally planar mandrel 60 having grooves 60a for receiving a heating element 28 that is formed in a generally serpentine shape (not shown) that complements the shape of the grooves 60a so that it can be fit and housed therein.

While the heater 20 has been shown with the heating element 28 as the primary heat generating component, it should be understood that other heating elements or components could be used. For example, an elongated one-piece, non-helical conductor or heating rod could be used in place of the helical-shaped heating element 28, thereby eliminating the need for both the heater core or mandrel 26 and heating element 28. For example, the lamp or light source 15 (FIG. 2) is situated in the reflector or director 14 and could be used as a heat or calorie source for heating a thermally-conductive material (not shown) supported in the reflector or deflector 30. The thermally-conductive material may be situated in proximity to the reflector or director 14 and lamp or light source 62 in order to act as a heat sink and to transfer heat. The thermally-conductive material may then have a portion (not shown) situated in the reflector or deflector 30 so that it could perform the condensation removal or de-icing as described earlier herein. For example, a fluid with sufficient thermal energy could heat a tube and act like the heating element 28 in the deflector.

Advantageously, the system and method described provide means and apparatus for de-icing and removing condensation. The FIGS. 2-4B show an upper half of the headlamp and/or a tail light assembly 10 with a single heater 20, but it should be understood that multiple heaters 20 could be incorporated in the headlamp and/or a tail light assembly 10. For example, a lower half 10a (FIG. 1A) of the headlamp and/or a tail light assembly 10 may also comprise a heating element 20 to de-ice or remove condensation from the bottom outer lens 23 (FIG. 1A). Alternatively, the heater 20 and deflector 30 could be mounted lower in the headlamp and/or a tail light assembly 10 so that it removes condensation or de-ices both the top outer lens 22 and the bottom outer lens 23.

This invention, including all embodiments shown and described herein, could be used alone or together and/or in combination with one or more of the features covered by one or more of the claims set forth herein, including but not limited to one or more of the features or steps mentioned in the bullet list in the Summary of the Invention and the claims.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A headlamp and/or tail light assembly comprising:
a housing;
an outer lens; and
a heater having:
a heater core for producing heat;
a deflector or reflector for receiving said heater core;
said deflector or reflector being configured to direct or reflect heat from said heating core toward said outer lens.

2. The headlamp and/or tail light assembly as recited in claim 1 wherein said deflector or reflector comprises an angled, curved or non-linear wall portion for directing or reflecting heat from said heater core to said outer lens.

3. The headlamp and/or tail light assembly as recited in claim 2 wherein said deflector or reflector comprises a first wall and a generally opposing second wall; at least one of said first wall or said second wall being angled or curved to direct or reflect heat from said heater core toward said outer lens.

4. The headlamp and/or tail light assembly as recited in claim 3 wherein each of said first wall and said generally opposing second wall are angled or curved to direct or reflect heat from said heater core toward said outer lens.

5. The headlamp and/or tail light assembly as recited in claim 1 wherein said deflector or reflector is generally U-shaped, V-shaped or L-shaped in cross section and further comprises a joining wall for joining a first wall and a second wall and cooperating therewith to provide or define a receiving area for receiving said heater core.

6. The headlamp and/or tail light assembly as recited in claim 1 wherein said heater is mounted on said housing.

7. The headlamp and/or tail light assembly as recited in claim 6 wherein said headlamp and/or a tail light assembly comprises a bezel having a recessed wall defining a bezel recessed area for receiving said heater.

8. The headlamp and/or tail light assembly as recited in claim 7 wherein said deflector or reflector comprises a deflector housing for receiving said heater core, said deflector housing being configured and adapted to be receiving in said bezel recessed area.

9. The headlamp and/or tail light assembly as recited in claim 8 wherein said deflector or reflector comprises a deflector housing having a wall that is curved, non-linear or angled at a predetermined angle to direct heat toward said outer lens.

10. The headlamp and/or tail light assembly as recited in claim 9 wherein said angle is about 45 degrees.

11. The headlamp and/or tail light assembly as recited in claim 9 wherein said deflector or reflector comprises a deflector housing having a wall edge in opposed and operative relationship with an inner surface of said outer lens.

12. The headlamp and/or tail light assembly as recited in claim 11 wherein said wall edge is spaced from said inner surface a distance of 10.0 mm or less.

13. The headlamp and/or tail light assembly as recited in claim 8 wherein said deflector housing comprises a first wall having a first wall edge associated with a first area of said outer lens and a second wall edge associated with a second area of said outer lens; said second edge being spaced a predetermined distance from said second area to define an opening between said second edge and said outer lens to facilitate the passing of convection currents across an inner surface of said outer lens.

14. The headlamp and/or tail light assembly as recited in claim 13 wherein said first edge is spaced a second predetermined distance from said first area.

15. The headlamp and/or tail light assembly as recited in claim 13 wherein said second wall is angled to direct or reflect heat from said heater core toward said opening.

16. The headlamp and/or tail light assembly as recited in claim 13 wherein said predetermined distance is less than 10.0 mm.

17. The headlamp and/or tail light assembly as recited in claim 15 wherein at least an inner surface of said deflector housing is metallized or said deflector or reflector is made of a metallic material.

18. The headlamp and/or tail light assembly as recited in claim 1 wherein said deflector or reflector comprises a deflector housing that is secured to said outer lens.

19. The headlamp and/or tail light assembly as recited in claim 18 wherein said deflector housing is molded to said outer lens.

20. The headlamp and/or tail light assembly as recited in claim 1 wherein said deflector or reflector comprises a deflector housing that is secured to said outer lens.

21. The headlamp and/or tail light assembly of claim 1 wherein said heater core is coupled to an electrical circuit for energizing said heater core.

22. The headlamp and/or tail light assembly as recited in claim 1 wherein said heater core comprises a mandrel for receiving and supporting a heating element.

23. The headlamp and/or tail light assembly as recited in claim 22 wherein said mandrel is generally cylindrical.

24. The headlamp and/or tail light assembly as recited in claim 23 wherein said heating element is a helically-shaped wire.

25. The headlamp and/or tail light assembly as recited in claim 22 wherein said mandrel is generally planar and comprises a plurality of channels for receiving a heating element for generating heat in response to current from an electrical circuit.

26. The headlamp and/or tail light assembly as recited in claim 22 wherein said mandrel is generally planar and comprises grooves for receiving said heating element.

27. The headlamp and/or tail light assembly as recited in claim 1 wherein said deflector or reflector is generally U-shaped, L-shaped or V-shaped in cross section and defines a deflector opening, said deflector or reflector being mounted in said headlamp and/or a tail light assembly such that said deflector opening is in operative relationship with said outer lens so that heat from said heater core is directed to said outer lens.

28. The headlamp and/or tail light assembly as recited in claim 22 wherein said heating element is a wire.

29. The headlamp and/or tail light assembly as recited in claim 1 wherein said outer lens comprises a convex or curved shape that defines a recessed area in said outer lens, said deflector or reflector having a housing that having an opening which generally opposes said recessed area.

30. The headlamp and/or tail light assembly as recited in claim 29 wherein the curved shape of the outer lens has two sides: one concave side which is the recessed area opposed to the opening of the deflector or reflector housing, and one convex side located inside a recess of the headlamp housing.

31. The headlamp and/or tail light assembly as recited in claim 29 wherein said heater is situated in said housing in opposed relationship to said recessed area.

32. The headlamp and/or tail light assembly as recited in claim 1 wherein said deflector or reflector comprises a deflector or reflector housing that is adapted to complement a shape of the outer lens in order to define an air channel that extends from below said deflector or reflector housing, generally horizontally or generally perpendicular toward said outer lens, then generally vertically upward or generally parallel to and across at least one surface of said outer lens.

33. The headlamp and/or tail light assembly as recited in claim 1 wherein said deflector or reflector comprises a deflector or reflector housing having a plurality of surfaces that are adapted to define a predetermined deflector or reflector shape or configuration, said outer lens having a predetermined outer lens shape or configuration, said predetermined deflector or reflector shape or configuration cooperating with said predetermined outer lens shape or configuration to define an air channel or passageway that has a generally vertical area in communication with a generally horizontal area for directing air toward a outer lens recessed area defined by said outer lens, said air channel or passageway also having a generally vertical area for directing air away from said outer lens recessed area and across a surface of said outer lens after it is heated by said heater.

34. The headlamp and/or tail light assembly as recited in claim 33 wherein said outer lens comprises a convex or curved shape that defines said outer lens recessed area, said deflector or reflector having a housing wall defining an opening which generally opposes said recessed area.

35. A heater for use in a headlamp and/or a tail light assembly comprising:
a heater core for producing heat;
a deflector or reflector for receiving and supporting said heater core; said deflector being configured to direct or reflect heat from said heating core toward an outer lens or transparent cover of the headlamp and/or a tail light assembly.

36. The heater as recited in claim 35 wherein said deflector or reflector is generally U-shaped, V-shaped or L-shaped in cross section and further comprises a joining wall for joining a first wall and a second wall and cooperating therewith to provide or define a receiving area for receiving said heater core.

37. The heater as recited in claim 35 wherein said heater is mounted on a bezel of the headlamp and/or a tail light assembly.

38. The heater as recited in claim 37 wherein said bezel comprises a recessed wall defining a bezel recessed area for receiving said heater.

39. The heater as recited in claim 38 wherein said deflector or reflector comprises a deflector or reflector housing for receiving said heater core, said deflector or reflector housing being configured and adapted to be receiving in said bezel recessed area.
